(19) United States
(12) Patent Application Publication
(10) Pub. No.: US 2023/0121404 A1
(43) Pub. Date: Apr. 20, 2023

(54) SEARCHING FOR NORMALIZATION-ACTIVATION LAYER ARCHITECTURES

(71) Applicant: Google LLC, Mountain View, CA (US)

(72) Inventors: Hanxiao Liu, Santa Clara, CA (US); Quoc V. Le, Sunnyvale, CA (US); Andrew Brock, London (GB); Karen Simonyan, London (GB)

(21) Appl. No.: 17/798,046

(22) PCT Filed: Feb. 8, 2021
(86) PCT No.: PCT/US2021/017122

§ 371 Date: Aug. 5, 2022

Related U.S. Application Data
(60) Provisional application No. 62/971,887, filed on Feb. 7, 2020.

(51) Int. Cl. G06N 3/08; G06N 3/04

(52) U.S. Cl. CPC G06N 3/08; G06N 3/04

(57) ABSTRACT

Methods, systems, and apparatus, including computer programs encoded on computer storage media, for searching for an architecture for an activation-normalization layer to be included in a neural network to replace a set of layers that receive a layer input comprising a plurality of values, apply one or more normalization operations to the values in the layer input to generate a normalized layer input, and apply an element-wise activation function to the normalized layer input to generate a layer output.

### CROSS-REFERENCE TO RELATED APPLICATION

This application claims priority to U.S. Provisional Pat. Application No. 62/971,887, filed Feb. 7, 2020, the entirety of which is hereby incorporated by reference.

### BACKGROUND

This specification relates to determining architectures for neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Some neural networks are recurrent neural networks. A recurrent neural network is a neural network that receives an input sequence and generates an output sequence from the input sequence. In particular, a recurrent neural network can use some or all of the internal state of the network from a previous time step in computing an output at a current time step. An example of a recurrent neural network is a long short-term memory (LSTM) neural network that includes one or more LSTM memory blocks. Each LSTM memory block can include one or more cells that each include an input gate, a forget gate, and an output gate that allow the cell to store previous states for the cell, e.g., for use in generating a current activation or to be provided to other components of the LSTM neural network.

### SUMMARY

This specification describes a system implemented as computer programs on one or more computers in one or more locations that determines an architecture for a normalization - activation neural network layer (also referred to as an “NA layer”). The determined architecture can then be used in a neural network in place of an existing set of layers that first performs normalization and then applies an element-wise activation function.

Particular embodiments of the subject matter described in this specification can be implemented so as to realize one or more of the following advantages.

By determining the architecture of the normalization -activation layer as described in this specification, the system can identify architectures that, particularly on image understanding or generation tasks, outperform conventional human-designed architectures, e.g., batch norm + ReLu. In other words, the inclusion of the identified architecture in a neural network can result in the neural network being able to be trained to convergence quickly by improving the stability of the training process and results in the trained neural network having improved performance on the target ask relative to conventional human-designed or searched architectures. The resulting normalization - activation layer architectures generalize to many different architectures, at least in part due to being evaluated on multiple different architectures during the search. During the search, the system can use one or more rejection criteria to leverage the “sparsity” of the search space in order to reduce the amount of computational resources consumed by the search.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural architecture search system.

FIG. 2 shows an example computation graph.

FIG. 3 is a flow diagram of an example process for searching for an architecture for an NA layer.

FIG. 4 is a flow diagram of an example process for performing an iteration of an evolutionary search process.

Like reference numbers and designations in the various drawings indicate like elements.

### DETAILED DESCRIPTION

This specification describes a system implemented as computer programs on one or more computers in one or more locations that determines an architecture for a normalization - activation neural network layer. The determined architecture can then be used in a neural network in place of an existing set of layers that first performs normalization and then applies an element-wise activation function.

The neural network can be trained to perform any kind of machine learning task, i.e., can be configured to receive any kind of digital data input and to generate any kind of score, classification, or regression output based on the input.

In some cases, the neural network is a convolutional neural network that is configured to perform an image processing task, i.e., receive an input image and to process the input image to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories.

In some cases, the neural network is a convolutional neural network that is configured to generate images, i.e., either unconditionally or conditioned on some context input. For example the neural network can be the generator neural network that is paired with one or more discriminator neural networks in a generative adversarial network (GAN) framework.

As another example, if the inputs to the neural network are Internet resources (e.g., web pages), documents, or portions of documents or features extracted from Internet resources, documents, or portions of documents, the task can be to classify the resource or document, i.e., the output generated by the neural network for a given Internet resource, document, or portion of a document may be a score for each of a set of topics, with each score representing an estimated likelihood that the Internet resource, document, or document portion is about the topic.

As another example, if the inputs to the neural network are features of an impression context for a particular advertisement, the output generated by the neural network may be a score that represents an estimated likelihood that the particular advertisement will be clicked on.

As another example, if the inputs to the neural network are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, if the input to the neural network is a sequence of text in one language, the output generated by the neural network may be a score for each of a set of pieces of text in another language, with each score representing an estimated likelihood that the piece of text in the other language is a proper translation of the input text into the other language.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, the task may be a keyword spotting task where, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent.

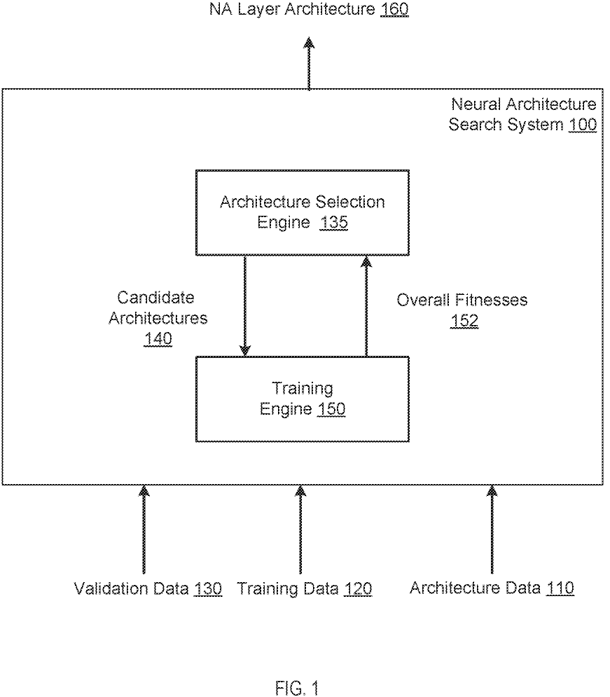

FIG. 1 shows an example neural architecture search system 100. The neural architecture search system 100 is an example of a system implemented as computer programs on one or more computers in one or more locations, in which the systems, components, and techniques described below can be implemented.

The neural architecture search system 100 is a system that searches for an architecture for a normalization - activation (NA) layer to be included in one or more neural networks. That is, instead of searching for an architecture for an entire neural network, the system 100 searches for an architecture only for an NA layer that will be included at one or more fixed positions within an existing neural network having an existing architecture, i.e., a manually-engineered architecture or one that has been generated through a different neural architecture search technique.

At a high level, the system 100 determines the architecture for the NA layer by generating a plurality of candidate architectures for the normalization - activation layer, evaluating how each of the generated candidate architectures perform when included in multiple different neural network architectures, and then selecting an architecture based on the results of the evaluation.

In other words, unlike conventional techniques for architecture search, instead of searching for an architecture for a neural network that can perform a task, the system 100 instead searches for an architecture for an NA layer that performs well when included as part of many different architectures that each perform the same task or that each perform different tasks.

In more detail, the system 100 obtains architecture data 110 that specifies a plurality of different neural network architectures.

Each neural network architecture includes at least one NA layer. An NA layer is a component of a neural network and can be included, e.g., after a convolutional layer, a recurrent layer, or a fully-connected layer, in a neural network architecture. As a particular example, the NA layer can be included after a layer that performs a linear transformation, e.g., a convolution or a matrix multiplication, and can receive as input the output of the layer that performs the linear transformation.

Generally, an NA layer is a component that is configured to receive a layer input that includes a plurality of values, apply one or more normalization operations to the values in the layer input to generate a normalized layer input, and apply an element-wise activation function to the normalized layer input to generate a layer output. Examples of normalization operations include those performed by batch normalization, group normalization, and layer normalization layers in order to normalize received inputs. Examples of element-wise activation functions include rectified linear unit (ReLU), inverse tangent, and sigmoid functions.

The system 100 also obtains, for each neural network architecture, respective training data 120 for training a neural network having the neural network architecture to perform a corresponding neural network task and validation data 130 for evaluating how well the neural network performs on the corresponding neural network task.

The system 100 can receive the training data 120, the validation 130, and the architecture data 110 in any of a variety of ways. For example, the system 100 can receive the data as an upload from a remote user of the system over a data communication network, e.g., using an application programming interface (API) made available by the system 100. As another example, the system 100 can receive an input from a user specifying which data that is already maintained by the system 100 should be used as the training and validation data 120 and 130 and the architecture data 110.

The system 100 then performs an iterative search process using the received data to search for an architecture for the NA layer.

In particular, at each iteration of the search process, a selection engine 135 generates one or more candidate architectures 140 for the NA layer.

Generally, the selection engine 135 selects the candidate architectures 140 from a specified search space of architectures for the NA layer. The search space of architectures defines the possible combinations of operations that can be performed by any NA layer to generate a layer output from a given layer input.

As a particular example, each possible candidate architecture in the search space can be represented as a computation graph that transforms one input tensor into an output tensor of the same shape. The computation graph includes a set of initial nodes representing tensors and a set of intermediate nodes representing outputs of primitive operations from a set of primitive operations.

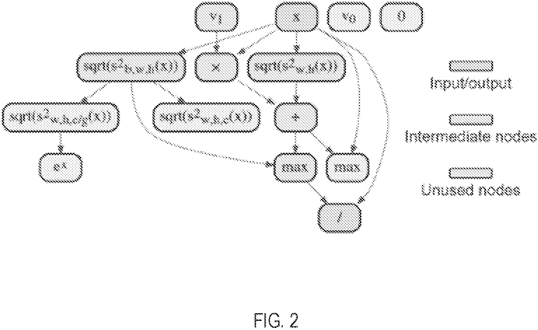

An example of such a computation graph is shown in FIG. 2.

In the example of FIG. 2, the computation graph is a directed acyclic graph (DAG) that has 4 initial nodes, including the input tensor to the NA layer and three auxiliary nodes: a constant zero tensor, and two trainable vectors v0 and v1 along the channel dimension initialized as 0's and 1's, respectively.

In general, the DAG can have any number of nodes, but in the example of FIG. 2, the DAG restricts the total number of nodes to fourteen: the 4 initial nodes plus 10 intermediate nodes. Each intermediate node in the DAG represents the outcome of one of a set of primitive operations, e.g., a set that includes unary and binary operations.

An example set of primitive operations that can be used to define the search space is shown in Table 1 below:

TABLE 1

| Element-wise Ops | Expression | Arity |
|---|---|---|
| Add | x + y | 2 |
| Mul | x × y | 2 |
| Div | x/y | 2 |
| Mak | max(x,y) | 2 |
| Neg | -x | 1 |
| Sigmoid | σ(x) | 1 |
| Tanb | tanh(x) | 1 |
| Exp | e^{x} | 1 |
| Log | sign(x) · \|n(\|x\|) | 1 |
| Abs | \|x\| | 1 |
| Square | x² | 1 |
| Sqrt | $\text{sign} \left(x\right) ⋅ \sqrt{\left\|x\right\|}$ | 1 |
| Aggregation Ops | Expression | Arity |
| 1^{st} order | µ_{I}(x) | 1 |
| 2^{nd} order | $\sqrt{μ x \left({x}^{2}\right)}$ | 1 |
| 2^{nd} order, centered | $\sqrt{S \frac{2}{I} \left(x\right)}$ | 1 |

In Table 1, the notation x_{I} represents a subset of x’s elements along the dimensions indicated by I. In particular, the index set I can take any value among {(b,w,h); (w,h,c); (w,h); (w, h, c/g)}, where b is the batch dimension, w is the width dimension, h is the height dimension, c is the channel dimension, and c/g indicates that aggregation is carried out in a grouped manner across the channel dimension. In any of the aggregation operations, a small amount of noise may be inserted as necessary for numerical stability. All the operations in Table 1 preserve the shape of the input tensor. Thus, µ_{I(x)} is a mapping that replaces each element in x with the 1st order moment of the set elements in x_{I}. Likewise, s²_{I(x)} is a mapping that transforms each element of x into the 2nd order moment among the elements in x_{I}.

The engine 135 can generate an architecture 140 by determining which nodes are connected by edges in the computation graph and which of the operations from the set of primitive operations, e.g., the operations in Table 1, correspond to each of the nodes in the computation graph.

At each iteration, the engine 135 can generate the candidate architectures 140 in any of a variety of ways. As a particular example, the system 100 can perform an evolution-based search.

In an evolution-based search, at the first iteration, the engine 135 can randomly generate a plurality candidate architectures 140 from the search space. For example, the engine 135 can randomly generate a candidate architecture 140 by generating a random computation graph in in a sequential manner. Starting from the initial nodes in the graph, the engine 135 generates each new node by randomly sampling a primitive operation and then randomly sampling its input nodes according to the operation’s arity. The process is repeated multiple times and the last node is used as the output.

At each subsequent iteration, the engine 135 can select a subset of candidate architectures from the candidate architectures that have already been generated at earlier iterations, select a candidate architecture from the subset of candidate architectures based on the overall fitnesses of the candidate architectures, and generate a new candidate architecture 140 from the selected candidate architecture. Overall fitnesses of candidate architectures and selecting candidate architectures 140 at subsequent iterations will be described in more detail below.

At each iteration, for each of the one or more candidate architectures 140 generated by the engine 135, a training engine 150 identifies two or more of the plurality of different neural network architectures specified by the architecture data 110. In some implementations, the training engine 150 identifies all of the multiple neural network architectures for all of the architectures 140. In some other implementations, the training engine 150 identifies a random subset of the multiple neural network architectures for each candidate 140.

For each candidate 140 and for each identified neural network architecture, the training engine 150 trains, on the respective training data 120 for the identified neural network architecture, a neural network having the identified neural network architecture but with the normalization - activation layers in the identified neural network architecture replaced with new normalization - activation layers having the candidate architecture 140.

Generally, because the system 100 is searching for an architecture only for the NA layer, the search space will be “sparse,” i.e., only a very small subset of the generated candidates 140 will result in a performance that is significantly better than a random guess when included in any given network architecture. To leverage this sparsity in order to minimize the computational resources consumed by the search process, the training engine 150 can apply one or more rejection criteria for rejecting a candidate 140. Rejection of a candidate 140 results in stopping the training of the rejected candidate 140 early (thereby saving computational resources), and then removing the candidate 140 from consideration.

As a particular example, the training engine 150 can reject any candidate architecture that has not achieved at least a threshold fitness when included in any of the two more neural network architectures after a threshold number of training steps. For example, if, for a given candidate 140, none of the two or more neural network architectures has received more than a threshold percentage, e.g., twenty percent or thirty percent, validation accuracy after a threshold number of training steps, e.g., fifty training steps, one hundred training steps, or one hundred and fifty training steps, the system can reject the candidate 140 and terminate the training.

As another particular example, the training engine 150 can reject any candidate 140 that is subject to numerical instability during training and terminate the training of the rejected candidate 140. To determine whether a candidate 140 is subject to numerical instability, the training engine 150 can, at one or more checkpoints during the training, perform multiple gradient ascent steps to adversarially adjust the model weights of a network architecture that includes the candidate towards the direction of maximizing the network’s gradient norm, i.e., maximizing the norm of the gradient of the network architecture on a batch of training inputs with respect to the model parameters. If the after performing the gradient ascent steps, the gradient norm exceeds a threshold, the training engine 150 can reject the candidate.

For each identified architecture, the training engine 150 determines a fitness from a measure of performance of the trained neural network on the validation data 130 for the identified neural network architecture. For example, the fitness can be the validation accuracy of the trained neural network on the validation data 130 or any other appropriate measure of the performance of a trained neural network, e.g., validation loss, an intersection over union measure, and so on.

The training engine 150 then determines an overall fitness 152 for the candidate architecture from the fitnesses for the two or more different identified neural network architectures.

After the termination of the search, i.e., after the last iteration of the iterative search process, the system 100 selects a final architecture for the NA layer based on the overall fitnesses 152 for the candidate architectures 140 that were generated during the search.

For example, the system 100 can select the candidate architecture 140 for the NA layer that had the best overall fitness.

As another example, the system 100 can select a subset of candidate architectures having the highest overall fitnesses and select a final architecture by evaluating the subset of candidate architectures on a target neural network task that is more computationally expensive than the corresponding neural network tasks for the architectures in the architecture 110.

In some implementations, after the search process has terminated, the system 100 can then output final architecture data 160 specifying the final architecture of the NA layer. For example, the system 100 can output data specifying the final NA layer architecture to the user that submitted the training data 120. For example, the final architecture data 160 can specify the primitive operations that are performed by the NA layer, the inputs to each of those primitive operations, and which output is used as the layer output of the NA layer.

In some implementations, after the final architecture has been selected, the system 100 trains a neural network that includes A-N layers having the determined architecture, e.g., either from scratch or to fine-tune the parameter values generated as a result of training during the search, and then uses the trained neural network to process requests received by users, e.g., through the API provided by the system.

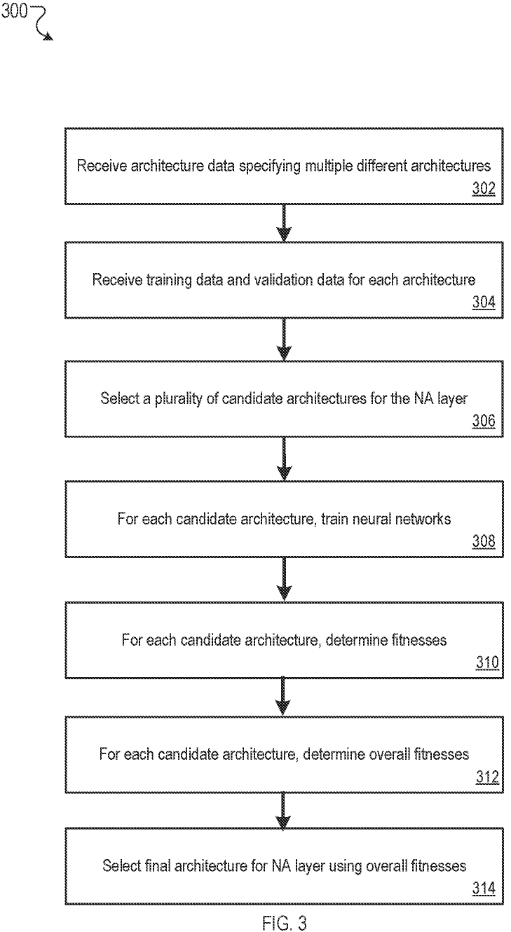

FIG. 3 is a flow diagram of an example process 300 for searching for an architecture for a NA layer. For convenience, the process 300 will be described as being performed by a system of one or more computers located in one or more locations. For example, a neural architecture search system, e.g., the neural architecture search system 100 of FIG. 1, appropriately programmed, can perform the process 300.

The system receives architecture data specifying a plurality of different neural network architectures (step 302), with each neural network architecture including at least one NA layer, and each NA layer being configured to: receive a layer input comprising a plurality of values; apply one or more normalization operations to the values in the layer input to generate a normalized layer input; and apply an element-wise activation function to the normalized layer input to generate a layer output.

The system receives, for each neural network architecture, respective training data for training a neural network having the neural network architecture to perform a corresponding neural network task and validation data for evaluating how well the neural network performs on the corresponding neural network task (step 304).

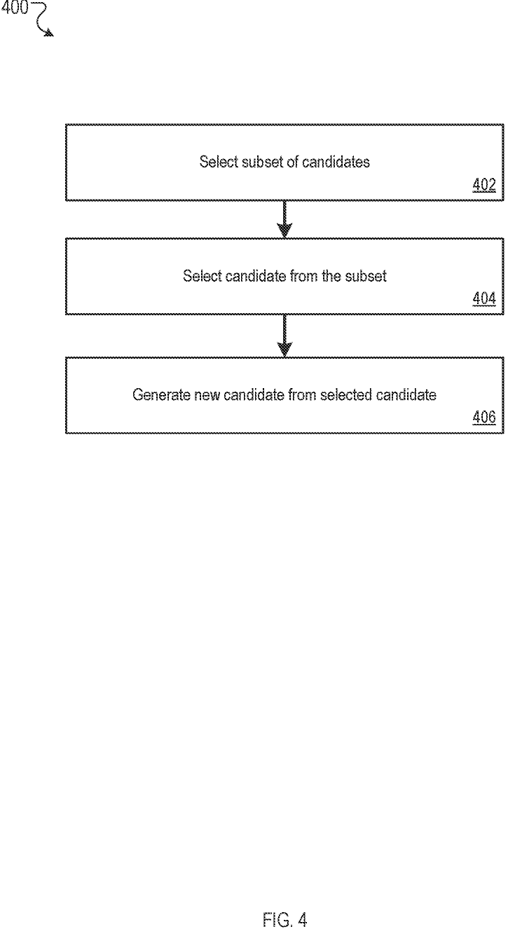

The system generates a plurality of candidate architectures for the normalization -activation layer (step 306). For example, the system can repeatedly generate candidate architectures by performing iterations of an evolutionary search process. Performing an iteration of an evolutionary search process is described in more detail below with reference to FIG. 4.

For each of the plurality of candidate architectures and for each of two or more of the plurality of different neural network architectures, the system trains, on the respective training data for the neural network architecture, a neural network having the neural network architecture but with the NA layers replaced with new NA layers having the candidate architecture (step 308) and determines a fitness from a measure of performance of the trained neural network on the validation data for the neural network architecture (step 310).

The system determines an overall fitness for the candidate architecture from the fitnesses for the two or more different neural network architectures (step 312). In some implementations, the overall fitness can be the average of the fitnesses for the two or more different architectures. In some other implementations, the overall fitness includes all of the fitnesses for the two or more different architectures, i.e., is a list of the overall fitnesses.

The system selects a final architecture for the normalization - activation layer based on the overall fitnesses for the candidate architectures (step 314).

FIG. 4 is a flow diagram of an example process 400 for performing an iteration of an evolutionary search process. For convenience, the process 400 will be described as being performed by a system of one or more computers located in one or more locations. For example, a neural architecture search system, e.g., the neural architecture search system 100 of FIG. 1, appropriately programmed, can perform the process 400.

In general, the system can repeatedly perform the process 400 to determine a final architecture for the NA layer.

More specifically, for the first iteration of the evolutionary search process, the system can randomly generate a plurality of candidate architectures and, at each subsequent iteration, can perform the process 400 to generate one or more candidate architectures for the iteration.

The system selects a subset of candidate architectures from the candidate architectures that have already been generated (step 402). For example, the system can randomly select a fixed size subset of the candidate architectures that have already been generated. In some cases, the system selects the fixed size subset only from a sliding window of only the most recent portion of the population, i.e., the most recently generated candidate architectures.

The system selects a candidate architecture from the subset of candidate architectures based on the overall fitnesses of the candidate architectures (step 404).

In particular, when the overall fitness is an average of the fitnesses for the two or more architectures, the system can select the candidate architecture with the best overall fitness of the candidate architectures in the subset.

When the overall fitness includes all of the fitnesses, the system can identify each candidate architecture from the subset that has an overall fitness that is not dominated by any overall fitness of any other candidate architecture from the subset. The system can then randomly selecting one of the identified candidate architectures. The overall fitness for a first architecture is dominated by the overall fitness for a second architecture when, for each of the two or more architectures, the fitness of the second architecture is at least as high as the fitness of the first architecture.

The system generates a new candidate architecture from the selected candidate architecture (step 406). In particular, the system can generate the new candidate architecture by mutating the selected candidate architecture. For example, the system can select an intermediate node in the computation graph at random and then select a new operation for the selected node from the set of primitive operations at random and select new predecessors for the selected operation at random. The system can then modify the selected candidate architecture to replace the corresponding operation and predecessors with the randomly selected primitive operation and predecessors.

As a result of performing the described search process using the techniques described above on the search space defined by the set of primitive operations described in Table 1, the system can identify high-performing NA layers that can be included in any of a variety of network architectures.

As a particular example, a neural network can include a normalization-activation layer between a first neural network layer and a second neural network layer. The first neural network layer, e.g., a layer that applies a linear transformation, generates first layer outputs having a plurality of elements the normalization-activation layer is configured to: receive a first layer output generated by the first neural network layer; and generate an activation output having a respective activation value for each element of the first layer output, wherein the activation value for each element of the layer input x satisfies any one of the following:

$$\frac{x}{max \left(\sqrt{{s}_{b}^{2} {{}_{,}}_{w , h} \left(x\right)} , x + \sqrt{{μ}_{w , h , o} \left({x}^{2}\right)}\right)} γ + β ,$$

$$\left(\frac{x}{max \left(\sqrt{{s}_{b}^{2} {{}_{,}}_{w , h} \left(x\right)} , {v}_{1} x + \sqrt{{s}_{w , h}^{2} \left(x\right)}\right)} γ + β\right| ,$$

$$- \frac{x σ \left(x\right)}{\sqrt{{s}_{b , w , h}^{2} \left(x\right)}} γ + β ,$$

$$\frac{x}{max \left({\sqrt{{s}_{b , w , h}^{2} \left(x\right)}}^{x} , \sqrt{{μ}_{w , h , o} \left({x}^{2}\right) - x}\right)} γ + β ,$$

or

$$\frac{x}{max \left(\sqrt{{s}_{b , w , h}^{2} \left(x\right)} , \sqrt{{μ}_{w , h} \left({x}^{2}\right) - x}\right)} γ + β ,$$

where β is a learned parameter.

As can be seen from the expressions above, these NA layers all have a batch dependency, i.e., each perform at least one operation that aggregates values across the batch dimension. In some cases, the system can constrain the search to not include any such operations in the set of primitive operations. In these cases, high performing NA layer architectures that can be used without batch dependence can include those that perform any of the following sets of operations. In this case, the NA layer generates an activation output having a respective activation value for each element of the first layer output, wherein the activation value for each element of the layer input x satisfies any one of the following:

$$\frac{x σ \left(x\right)}{\sqrt{{μ}_{w , h , e / g} \left({x}^{2}\right)}} γ + β ,$$

$$\frac{x σ \left({v}_{1} x\right)}{\sqrt{{s}_{w}^{2} {}_{, h , e / g} \left({x}^{2}\right)}} γ + β ,$$

$$\frac{x tanh \left(σ \left(x\right)\right)}{\sqrt{{μ}_{w , h , e / g} \left({x}^{2}\right)}} γ + β ,$$

$$\frac{x σ \left(x\right)}{\sqrt{{s}_{w}^{2} {}_{, h , e / g} \left({x}^{2}\right)}} γ + β ,$$

or

$$Z σ \left(max \left(x , Z\right)\right) γ + β , Z = \frac{x}{\sqrt{{μ}_{w , h , e / g} \left({x}^{2}\right)}} .$$

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, .e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method comprising:
receiving data specifying a plurality of different neural network architectures, each neural network architecture including at least one normalization - activation layer, each normalization -activation layer configured to:
receive a layer input comprising a plurality of values;
apply one or more normalization operations to the values in the layer input to generate a normalized layer input; and
apply an element-wise activation function to the normalized layer input to generate a layer output;
receiving, for each neural network architecture, respective training data for training a neural network having the neural network architecture to perform a corresponding neural network task and validation data for evaluating how well the neural network performs on the corresponding neural network task;
generating a plurality of candidate architectures for the normalization - activation layer;
for each of the plurality of candidate architectures:
for each of two or more of the plurality of different neural network architectures:
training, on the respective training data for the neural network architecture, a neural network having the neural network architecture but with the normalization - activation layers replaced with new normalization - activation layers having the candidate architecture; and
determining a fitness from a measure of performance of the trained neural network on the validation data for the neural network architecture; and
determining an overall fitness for the candidate architecture from the fitnesses for the two or more different neural network architectures; and
selecting a final architecture for the normalization - activation layer based on the overall fitnesses for the candidate architectures.

2. The method of claim 1, wherein the activation - normalization layers in two or more of the plurality of architectures apply batch normalization followed by a ReLu activation function.

3. The method of claim 1, wherein the neural network task, the training data, and the validation data are the same for all of the plurality of neural network architectures.

4. The method of claim 1, wherein generating a plurality of candidate architectures for the normalization - activation layer comprises repeatedly performing the following:
selecting a subset of candidate architectures from the candidate architectures that have already been generated;
selecting a candidate architecture from the subset of candidate architectures based on the overall fitnesses of the candidate architectures; and
generating a new candidate architecture from the selected candidate architecture.

5. The method of claim 4, wherein the generating comprises: randomly generating a plurality of initial candidate architectures.

6. The method of claim 4, wherein the overall fitness is an average of the fitnesses for the two or more architectures and wherein selecting a candidate architecture comprises selecting the candidate architecture with a best overall fitness.

7. The method of claim 4, wherein the overall fitness includes all of the fitnesses for the two or more architectures and wherein selecting a candidate architectures comprises:
identifying one or more candidate architectures from the subset that have overall fitnesses that are not dominated by any overall fitness of any other candidate architecture from the subset; and
randomly selecting one of the one or more identified candidate architectures.

8. The method of claim 1, wherein the candidate architectures are represented as a computation graph that transforms one input tensor into an output tensor of the same shape.

9. The method of claim 8, wherein the computation graph includes a set of initial nodes representing tensors and a set of intermediate nodes representing outputs of primitive operations from a set of primitive operations,.

10. The method of claim 9 , wherein generating the new architecture comprises:
selecting an intermediate node at random;
selecting a new operation for the selected node from the set of primitive operations at random; and
selecting new predecessors for the selected node at random.

11. The method of claim 1, wherein the training comprises:
rejecting any candidate architecture that has not achieved at least a threshold fitness on when included in any of the two more neural network architectures after a threshold number of training steps.

12. The method of claim 1, further comprising: rejecting any candidate architecture that is subject to numerical instability.

13. The method of claim 1, wherein selecting a final architecture for the normalization - activation layer based on the overall fitnesses for the candidate architectures comprises:
selecting a subset of candidate architectures having the highest overall fitnesses; and
selecting a final architecture by evaluating the subset of candidate architectures on a target neural network task that is more computationally expensive than the corresponding neural network tasks.

14. (canceled)

15. One or more non-transitory computer-readable storage media storing instructions that when executed by one or more computers cause the one or more computers to perform operations comprising;
receiving data specifying a plurality of different neural network architectures, each neural network architecture including at least one normalization - activation layer, each activation layer configured to:
receive a layer input comprising of values;
apply more normalization operations to the values in the layer input to generate a normalized layer input; and
apply an element-wise activation function to the normalized layer input to generate a layer output;
receiving, for each neural network architecture, respective training data for training a neural network having a neural network architecture to perform a corresponding neural network task and validation data for evaluating how well the neural network performs on the corresponding neural network task;
generating a plurality of candidate architectures for the normalization - activation layer, for each of the plurality of candidate architectures:
for each of two or more of the plurality of different neural network architectures:
training, on the respective training data for the neural network architecture, a neural network having the neural network architecture but with the normalization - activation layers replaced with new normalization - activating layers having the candidate architecture; and
determining a fitness from a measure of performance of the trained neural network on the validation data for the neural network architecture; and
determining an overall fitness for the candidate architecture from the fitnesses for the two or more different neural network architectures; and
selecting a final architecture for the normalization - activation layer based on the overall fitnesses for the candidate architectures.

16. A system comprising one or more computers and one or more storage devices storing instructions that when executed by the one or more computers cause the one or more computers to perform operations comprising:
receiving data specifying a plurality of different neural network architectures, each neural network architecture including at least one normalization - activation layer, each normalization -activation layer configured to:
receive a layer input comprising a plurality of values;
apply one or more normalization operations to the values in the layer input to generate a normalized layer input; and
apply an element-wise activation function to the normalized layer input to generate a layer output;
receiving, for each neural network architecture, respective training data for training a neural network having the neural network architecture to perform a corresponding neural network task and validation data for evaluating how well the neural network performs on the corresponding neural network task;
generating a plurality of candidate architectures for the normalization - activation layer;
for each of the plurality of candidate architectures:
for each of two or more of the plurality of different neural network architectures:
training, on the respective training data for the neural network architecture, a neural network having the neural network architecture but with the normalization - activation layers replaced with new normalization - activation layers having the candidate architecture; and
determining a fitness from a measure of performance of the trained neural network on the validation data for the neural network architecture; and
determining an overall fitness for the candidate architecture from the fitnesses for the two or more different neural network architectures; and
selecting a final architecture for the normalization - activation layer based on the overall fitnesses for the candidate architectures.

17. The system of claim 16, wherein the activation - normalization layers in two or more of the plurality of architectures apply batch normalization followed by a ReLu activation function.

18. The system of claim 16, wherein the neural network task, the training data, and the validation data are the same for all of the plurality of neural network architectures.

19. The system of claim 16, wherein generating a plurality of candidate architectures for the normalization - activation layer comprises repeatedly performing the following:
selecting a subset of candidate architectures from the candidate architectures that have already been generated;
selecting a candidate architecture from the subset of candidate architectures based on the overall fitnesses of the candidate architectures; and
generating a new candidate architecture from the selected candidate architecture.

20. The system of claim 19, wherein the generating comprises: randomly generating a plurality of initial candidate architectures.

21. The system of claim 19, wherein the overall fitness includes all of the fitnesses for the two or more architectures and wherein selecting a candidate architectures comprises:
identifying one or more candidate architectures from the subset that have overall fitnesses that are not dominated by any overall fitness of any other candidate architecture from the subset; and
randomly selecting one of the one or more identified candidate architectures.
